(19) United States
(12) Patent Application Publication
(10) Pub. No.: US 2003/0006053 A1
(43) Pub. Date: Jan. 9, 2003

(54) Operating system for hydraulic rock drill

(76) Inventor: Paul B. Campbell JR., Troutville, VA (US)

Correspondence Address: Paul B. Campbell Jr., Botetourt County, 271 Laymantown Rd., Troutville, VA, 24175-6715, US

(21) Appl. No.: 10/178,978

(22) Filed: Jun. 25, 2002

Related U.S. Application Data
(60) Provisional application No. 60/300,891, filed on Jun. 25, 2001.

(51) Int. Cl. B25D 9/00

(52) U.S. Cl. 173/206

(57) ABSTRACT

An operating system for a hydraulic rock drill in which the impact piston and rotation motor are hydraulically connected in series. The advantages are simplicity of connections, automatic torque increase when required without reducing impact power, and automatic reduction of impact power if the rotation stalls.

### CROSS-REFERENCE TO RELATED APPLICATIONS

This invention is used on the hydraulic rock drill of co-pending applications entitled “Steel Retainer for Rock Drill” and “Valve for Hydraulic Rock Drill”, both filed Jun. 25, 2002. This application is entitled to the benefit of Provisional Patent Application Ser. No. 60/300891, filed Jun. 25, 2001.

### BACKGROUND

1. Field of Invention

This invention relates specifically to a hydraulic rock drill designed for small mounted applications, incorporating characteristics that contribute to improved performance and easier maintenance.

2. Description of Prior Art

A percussive rock drill is a device that, in conjunction with a drill bit, uses rotation and percussive energy to drill a hole in rock for purposes of blasting, etc. Every fluid operated percussive rock drill includes certain basic features. A striking piston imparts impact energy to a drill steel and bit, and a valving mechanism directs the working fluid so as to cause reciprocating motion of the piston. A rotation mechanism causes the drill steel to rotate to give the bit a fresh rock surface to strike with each blow, and a drill steel retention mechanism allows retraction of the drill steel and bit when the hole is completed. Flushing fluid (typically air or water) travels through holes in the drill steel and bit to blow rock cuttings out of the drilled hole.

In a typical operation of a hydraulic rock drill, the striking piston is caused to reciprocate by variable hydraulic forces. The drill steel is constrained and located by a chuck mechanism and a steel retainer, and is caused to rotate by a mechanism such as a hydraulic motor driving through a gear reduction. A drill bit is attached to the end of the drill steel, and the combination of impact and rotation causes the drill bit to penetrate the rock. Finally, some type of fluid energy storage mechanism is used to provide relatively constant pressure sources of working fluid for the piston and rotation.

Manufacturers of small drilling rigs, designed to drill holes in the range of 1¼to 2 inch diameter, typically use hand-held drills that are modified for mounted use. Modifications may be as simple as removing handles and locking control valves in the “on” position. The advantage of using hand-held tools in these applications is the simplicity of fluid connections; one supply and one exhaust hose serve both impact and rotation, as opposed to larger drills in which separate hoses are required for each function. One disadvantage of using hand-held tools is that rotation torque is typically low. Since the rotation robs power from the impact, rotation power is deliberately limited in order to maximize impact power. Another disadvantage is that if the rotation stalls, the impact power continues unabated or even increases, which can cause jamming of the drill bit into the drilled hole.

### SUMMARY

An object of the present invention is to preserve the simplified hose connection of a hand-held tool while providing adequate rotation torque for mounted applications. A second object is to provide a means for automatically reducing or stopping the impact if the rotation stalls. A third object is to provide a means for automatically adjusting the available rotation torque in response to drilling requirements.

### DRAWING FIGURES

FIG. 1 shows a simplified cross-sectional view of a hydraulic rock drill that embodies the objects of this invention.

FIG. 2 shows the fluid interconnection between the impact and rotation mechanisms, with the impact piston moving in a return direction.

FIG. 3 shows the fluid interconnection between the impact and rotation mechanisms, with the impact piston moving in a drive direction.

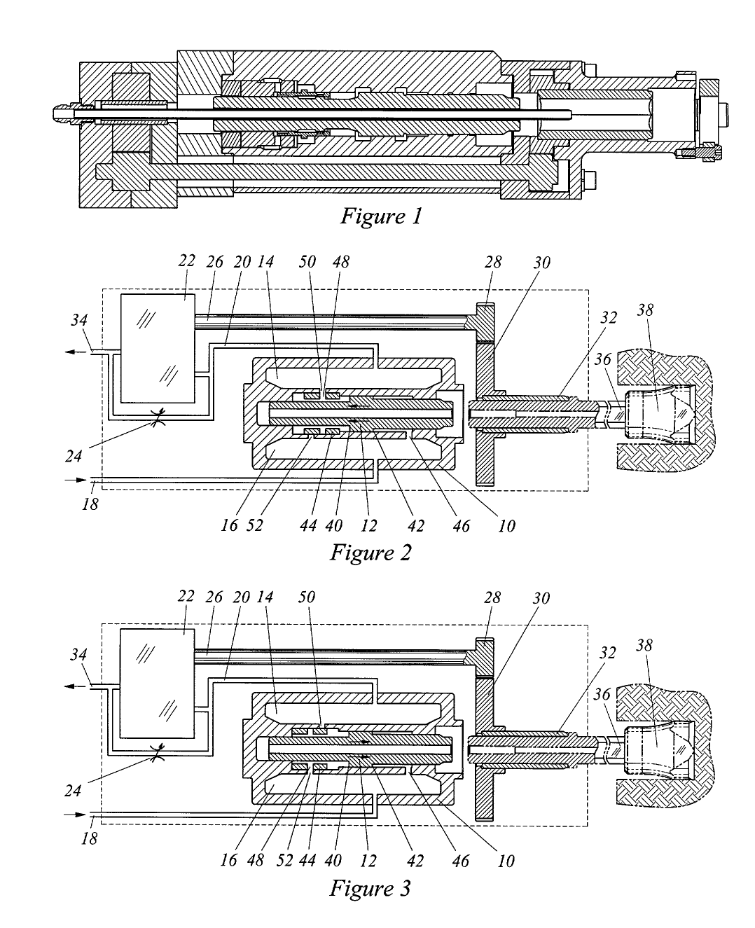

### DESCRIPTION OF IMPROVEMENT

Conventional hand-held hydraulic drills use a parallel fluid system in which the available fluid flow is divided internally. Most of the flow goes to the impact mechanism but a small portion is diverted to a hydraulic rotation motor. Higher rotation speed requires more flow and hence reduces the available flow to the impact mechanism, whereas lower rotation speed sends more flow to the impact mechanism. In the worst case scenario, the rotation can stall and send all flow to the impact mechanism. In the absence of rotation, the bit no longer has a fresh rock surface on which to impact, and further penetration into the rock is nearly impossible. If operation continues, the usual result is a broken or stuck bit. In a hand-held operation, the operator can compensate for a weak rotation by not pushing the drill bit into the rock with as much force whenever there is a tendency to stall. In a mounted application feed force is fixed, and the only solution to repeated rotation stalling is to reduce the fixed feed force. However, inadequate feed force results in a loss of drilling efficiency. FIG. 2 shows an improved device (the object of this invention) that uses a series fluid system in which flow passes first through the impact mechanism and then through the rotation motor. High pressure reservoir 16 is connected to an external pressure source through passage 18. Intermediate pressure reservoir 14 is connected to rotation motor 22 through passage 20. Exhaust fluid from impact piston 12 accumulates in reservoir 14. The power required to operate the rotation is typically less than one third the power required to operate the impact mechanism, so a rotation motor designed to use most of the available impact exhaust flow can run at low pressure and still deliver adequate torque. Rotation motor speed can be adjusted by bypassing a controlled amount of fluid through flow control valve 24 direct to return hose connection 34. Since this bypass flow occurs at low pressure, the power lost to inefficiency is low. Rotation motor 22 turns shaft 26, gear 28, and gear 30. Chuck 32 locates drill steel 36 in the proper position for impact by piston 12 and also transmits the rotation of gear 30 to drill steel 36 and drill bit 38.

The operating system as described will not work properly if a conventional impact device is simply connected in series with an existing rotation motor. The impact device must be specifically designed to use the operating system, as explained below.

Referring to FIGS. 2 and 3, impact piston 12 is reciprocably mounted in housing 10 and is moved in alternate directions by hydraulic forces acting against shoulders 40 and 42. Shoulder 42 is typically connected to high pressure reservoir 16 through port 46 so that shoulder 42 is exposed to a substantially constant high pressure. Shoulder 40 is alternately connected to high pressure reservoir 16 or intermediate pressure reservoir 14 by the action of valve 44. Shoulder 40 is larger than shoulder 42 by a predetermined value such that the area ratio between the two shoulders is fixed.

In FIG. 2, shoulder 40 is connected to intermediate pressure reservoir 14 through ports 48 and 50. The pressure in high pressure reservoir 16 is considerably higher than the pressure in intermediate pressure reservoir 14 so impact piston 12 is moving leftward even though shoulder 40 is larger than shoulder 42. Hydraulic fluid is being pushed by shoulder 40 into intermediate pressure reservoir 14. Accumulated fluid in intermediate pressure reservoir 14 is a supply source for rotation motor 22 through passage 20. The pressure in intermediate pressure reservoir 14 is a direct function of the torque requirement of motor 22. If the torque requirement of motor 22 is low then the pressure in reservoir 14 is low. Conversely, if the torque requirement of motor 22 is high then the pressure in reservoir 14 must also be high in order to maintain rotation of motor 22. If the pressure in reservoir 14 rises high enough to stop the leftward motion of impact piston 12, then both motor 22 and impact piston 12 will stall. If shoulder 40 is too large relative to shoulder 42, then stalling will occur at too low a pressure in reservoir 14 and the useful torque of motor 22 will be limited. Thus it may be seen that the relationship between shoulder 40 and shoulder 42 is critical to the proper functioning of the operating system that is the subject of this patent. In a typical hydraulic drill, the area of shoulder 40 might be about three times the area of shoulder 42. In a hydraulic drill using the subject operating system, shoulder 40 might be only about two times the value of shoulder 42.

In FIG. 3, shoulder 40 is connected to high pressure reservoir 16 through ports 48 and 52. Since shoulder 40 is larger than shoulder 42, the net force is to the right and piston 12 moves rightward.

The maximum benefit of this operating system can be realized by operating on a fixed flow hydraulic system wherein normal operation occurs at about 80% of maximum system pressure. For example, suppose the subject hydraulic drill operates normally at 10 gpm (gallons per minute) at 1750 psi (pounds per square inch). Then the appropriate hydraulic system would be a fixed displacement pump delivering ten gpm with a maximum permissible system pressure of 2200 psi. When a higher torque requirement is encountered, the inlet pressure to the rotation motor automatically increases in an attempt to maintain the same motor flow rate against greater resistance. Since the operating pressure drop across the impact mechanism is nearly constant, an increase in the motor inlet pressure (and hence the impact mechanism exhaust pressure) is answered by an increase in the impact inlet pressure. By this method a higher torque is automatically achieved while maintaining a substantially constant impact power. If the rotation pressure increases too far and the required impact inlet pressure exceeds the maximum system pressure, the impact mechanism and rotation motor will both slow down or stall, alerting the machine operator to take appropriate action. Operation is restored by reducing or removing the feed force, without the necessity of trying to free a stuck bit.

U.S. Pat. No. 3,822,752 (Roger Montabert, Jul. 5, 1974) describes a series fluid system for a hydraulic drill. However, this prior art is more complicated than the present invention and differs in significant other ways. The earlier invention reverses the order of the current invention by passing the fluid first through the rotation motor and then through the impact mechanism. The invention is shown in two embodiments. The first embodiment uses the same amount of total flow for both rotation and impact functions, and a separate pressure regulator valve is required for proper operation. The second embodiment provides additional flow to the impact mechanism via an additional hose feeding through a pressure compensated flow control valve. In both embodiments, some of the simplicity of the series fluid system is lost because of the requirement for an external control valve. Furthermore, additional rotation torque is achieved only at the expense of rotation speed and impact power. A higher torque requirement increases the resistance to flow, and in a fixed pressure hydraulic system, the flow is automatically reduced when flow resistance increases. The rotation motor is a fixed displacement device with a direct relationship between flow and rotation speed, so lower flow causes the rotation motor to slow down. Pressure drop across the impact mechanism is directly related to flow, so the reduced flow passing through the rotation motor and impact mechanism lowers the impact mechanism inlet pressure and hence the rotation motor exhaust pressure. It is the increased pressure drop across the rotation motor that creates more torque, but the immediate and corresponding effect is a loss of impact power unless additional flow is supplied to the impact mechanism. While reduced impact power with higher torque may be advantageous in some situations, as when encountering varying rock conditions as described in the Montabert patent, it is detrimental in others. Varying rock conditions are not the only situation in which higher rotation torque is required. For example, when drilling larger diameter holes, both high rotation torque and high impact power are necessary. The present invention automatically achieves a higher rotation torque when required, without sacrificing impact power.

### CONCLUSION, RAMIFICATIONS, AND SCOPE

The reader will see that the hydraulic drill operating system described herein achieves the following desired advantages

it preserves the simplicity of the two-hose connection common to hand-held tools, and

it eliminates the possibility of continuing to impact after the rotation has stalled, and

it automatically increases available rotation torque when required, without reducing impact power.

Although the description above contains many specificities, these should not be construed as limiting the scope of the invention but as merely providing an illustration of the preferred embodiment of this invention. For example, in the preferred embodiment the valve is shown as being concentric with the piston. In an alternative embodiment the valve might be a spool valve or other valve means. Likewise in the preferred embodiment the valve and piston are connected to fluid reservoirs. In an alternative embodiment the valve and piston might be connected to nitrogen-charged accumulators. In the example of a typical hydraulic system, a specific pressure and flow mentioned. The subject operating system is not limited to any particular pressure or flow.

Thus the scope of the invention should be determined by the appended claims and their legal equivalents, rather then by the examples given.

I claim:

1. A hydraulic rock drill, comprising
a. a first housing having a piston bore and valve bore formed therein
b. a piston axially disposed in said piston bore and a valve axially disposed in said valve bore
c. a second housing having a rotation motor contained therein
d. fluid connection means between said first housing and said second housing
e. a fluid inlet connection to said first housing
f. a fluid exhaust connection from said second housing.

2. A hydraulic rock drill as in claim 1 wherein said fluid connection means contains a fluid accumulating reservoir.

3. A hydraulic rock drill as in claim 2 wherein the pressure in said fluid accumulating reservoir is maintained at some intermediate pressure between the pressure at said inlet connection of said first housing and the pressure at said exhaust connection of said second housing.

4. A hydraulic rock drill as in claim 3 wherein said intermediate pressure is a function of the torque requirement of said rotation motor.

5. A hydraulic rock drill as in claim 4 wherein an increased torque requirement of said rotation motor causes an increase in said intermediate pressure and the pressure at said inlet connection, whereby the impact power produced by said piston is maintained.

6. A hydraulic rock drill as in claim 1 wherein fluid passes first through said first housing and then into said second housing.

7. A hydraulic rock drill as in claim 6 wherein fluid passing through said first housing causes said piston to reciprocate and the same fluid passing through said second housing causes said rotation motor to rotate, whereby the rotation of said rotation motor cannot cease without also causing the reciprocation of said piston to cease.

8. A hydraulic rock drill as in claim 7 wherein a limited amount of fluid from said first housing is allowed to bypass said rotation motor within said second housing whereby the rotating speed of said rotation motor is limited.
